(19) United States
(12) Patent Application Publication
(10) Pub. No.: US 2006/0058130 A1
(43) Pub. Date: Mar. 16, 2006

(54) Belt-driven conical-pulley transmission, method for producing it, and motor vehicle having such a transmission

(75) Inventors: Martin Vornehm, Buhl (DE); Ronald Glas, Achern (DE); Remi Leorat, Strasbourg (FR); Lidia Burkovski, Neuenstadt am Kocher (DE); Peter Schmid, Gaggenau (DE); Alexander Fidlin, Karlsruhe (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/208,453

(22) Filed: Aug. 20, 2005

Related U.S. Application Data
(60) Provisional application No. 60/662,424, filed on Mar. 16, 2005.

(30) Foreign Application Priority Data
Aug. 24, 2004 (DE) 10 2004 040 826.2
Aug. 28, 2004 (DE) 10 2004 041 715.6
Sep. 4, 2004 (DE) 10 2004 042 883.2
Sep. 9, 2004 (DE) 10 2004 043 536.7
Sep. 14, 2004 (DE) 10 2004 044 190.1
Sep. 22, 2004 (DE) 10 2004 046 213.5

(51) Int. Cl. F16H 61/00; F16H 55/56; F16H 59/00

(52) U.S. Cl. 474/28; 474/8; 474/18

(57) ABSTRACT

A belt-driven conical-pulley transmission having a pair of conical disks on a power input side and carried on an input shaft, and a pair of conical disks on an output side of the transmission and carried on an output shaft, each pair of conical disks including an axially fixed disk and an axially movable disk. An endless torque-transmitting means extends around and is in contact with the input side disks and the output side disks for transmitting torque between the pairs of disks. The transmission is optimized to minimize noise emitted by the transmission when it is in operation.

### CROSS-REFERENCE TO RELATED APPLICATION

This application claims the benefit of U.S. Provisional Application Ser. No. 60/662,424, filed on Mar. 16, 2005.

### BACKGROUND OF THE INVENTION

1. Field of the Invention

The present invention relates to an automatic transmission in the form of a belt-driven conical-pulley transmission, as known for example from DE 10 2004 015 215 and other publications, as well as a method for producing it and a motor vehicle equipped with it.

2. Description of the Related Art

Automatic transmissions in the broader sense are converters, whose momentary transmission ratio changes automatically, in steps or continuously, as a function of present or anticipated operating conditions, such as partial load and coasting, and environmental parameters, such as, for example, temperature, air pressure, and, humidity. They include converters that are based on an electrical, pneumatic, hydrodynamic, or hydrostatic principle, or on a principle which is a mixture of those principles.

The automation refers to a great variety of functions, such as start-up, choice of transmission ratio, or the type of transmission ratio change in various operating situations, where the type of transmission ratio change can mean, for example, shifting to different gear steps in sequence, skipping gear steps, and the speed of shifting.

The desire for convenience, safety, and reasonable construction expense determines the degree of automation, i.e., how many functions take place automatically.

As a rule, the driver can intervene manually in the automatic sequence, or can limit it for individual functions.

Automatic transmissions in the narrower sense, as they are used today primarily in the construction of motor vehicles, usually have the following structure:

On the input side of the transmission there is a start-up unit in the form of a regulatable clutch, for example a wet or dry friction clutch, a hydrodynamic clutch, or a hydrodynamic converter.

With a hydrodynamic converter or a hydraulic coupling, often a bridging clutch or lock-up clutch is connected parallel to the pump and turbine parts, which increases the efficiency by transferring the force directly and damps vibrations through defined slippage at critical rotational speeds.

The start-up unit drives a mechanical, continuously variable or stepped, multi-speed gearbox, which can include a forward/reverse driving unit, a main group, a range group, a split group, and/or a variable speed drive. Gearbox groups can be of intermediate gear or planetary design, with straight or helical tooth system, as a function of the requirements in terms of quietness of operation, space conditions, and transmitting options.

The output element of the mechanical transmission, a shaft or a gear, drives a differential directly or indirectly via intermediate shafts or an intermediate stage with constant transmission ratio, which can be configured as a separate gearbox or is an integral component of the automatic transmission. In principle, the transmission is suitable for longitudinal or transverse installation in the motor vehicle.

To adjust the transmission ratio in the mechanical transmission there are hydrostatic, pneumatic, and/or electrical actuators. A hydraulic pump, which operates on the displacement principle, supplies oil under pressure for the start-up unit, in particular the hydrodynamic unit, for the hydrostatic actuators of the mechanical transmission, and for lubricating and cooling the system. As a function of the necessary pressure and delivery volume, possibilities include gear pumps, screw pumps, vane pumps and piston pumps, the latter usually of radial design. In practice, gear pumps, vane pumps, and radial piston pumps have come to predominate for that purpose, with gear pumps and vane pumps offering advantages because they are less expensive to build, and the radial piston pump offering advantages because of its higher pressure level and better regulation ability.

The hydraulic pump can be located at any desired position in the transmission, on a main or a secondary shaft that is constantly driven by the drive unit.

Continuously variable automatic transmissions are known that consist of a start-up unit, a reversing planetary gearbox as the forward/reverse drive unit, a hydraulic pump, a variable speed drive, an intermediate shaft and a differential. The variable speed drive, in turn, consists of two pairs of conical disks and an endless torque-transmitting means. Each pair of conical disks includes a second conical disk that is movable in the axial direction. Between those pairs of conical disks passes the endless torque-transmitting means, for example a steel thrust belt, a tension chain, or a drive belt. Moving the second conical disk changes the running radius of the endless torque-transmitting means, and thus the transmission ratio of the continuously variable automatic transmission.

Continuously variable automatic transmissions (CVT) require a high level of pressure in order to be able to move the conical disks of the variable speed drive with the desired speed at all operating points, and also to transmit the torque with a sufficient base contact pressure with minimum wear.

In motor vehicles the need for comfort and convenience is generally very high, especially in regard to the noise level. The driver and passengers, especially in upscale vehicles, want there to be no disturbing noises coming from the operation of the vehicle's mechanical units. But the internal combustion engine, and also other mechanical units such as transmissions, does produce sounds, which can be widely perceived as disturbing. Thus, for example, in continuously variable transmissions where a plate-link chain is used there can be a sound, since such a plate-link chain, because of its construction with plate links and pins, produces a recurring impact due to the pins striking the conical disks of the transmission. In CVT transmissions, acoustic effects are generally attributed to the pin impact as the source. That acoustic excitation then produces resonances at the natural frequencies of the transmission housing (FE modes) or of the shafts (torsional modes, bending modes).

Another acoustic effect is produced by the CVT belt, the CVT band, or the CVT chain, which can vibrate on the tension side like a musical string; that can be suppressed for example by a slide bar. Torsional friction vibrations at frequencies of 10 Hz are known in clutches, for example, as grabbing. If the coefficient of friction gradient is such that the coefficient of friction decreases with increasing relative rotational speed or velocity, as the slippage changes, grabbing results. In automatic transmissions it is primarily the steel-to-paper coefficient of friction that is relevant.

### SUMMARY OF THE INVENTION

Part of the purpose of the present invention is to improve the acoustics of such a transmission, and thus to improve the comfort—in particular the sound comfort —of a motor vehicle equipped with such a transmission. Another part of the purpose of the present invention is, after analyzing strong CVT vibrations and clarifying the associated operating mechanisms, to design appropriate countermeasures for minimizing—or if possible preventing—those vibrations, which lie for the most part in the acoustic range on the order of 400-600 Hz. Another part of the purpose of the present invention is to increase the endurance strength of components, and thus to prolong the operating life of such an automatic transmission. The reason for another part of the purpose of the present invention is to increase the torque transmission capability of such a transmission and to be able to transmit greater forces through the components of the transmission. Furthermore—hence that is another part of the purpose—it should be possible to economically produce such a transmission.

The parts of the problem are solved by the invention along with its refinements, presented in the claims and in the description, and are explained in connection with the drawing figures.

The analysis produces a simulation-based understanding of the nature of the vibration form, which involves a movement of the encircling chain coupled with a tipping or bending of the particular conical disk. The primary determinants of the frequency of the vibrations are the mass of the chain and the overall tipping and bending stiffness of the conical disks. That stiffness includes the inherent dishing of the disks, the tipping of the disks, the bending of the shafts as a result of their elasticity, and the tilt of the shafts as result of differences in bearing rigidities or bearing spacings. In addition, the coefficient of friction level and the gradient of the coefficient of friction, as well as the rotational speed and the transmission ratio, are determinants of the frequency.

Those findings are surprising, inasmuch as vibrations of the chain in the encircling arc, i.e., while it is being clamped in the disk set, have not been described before, and are also contrary to the view held heretofore that the frictional contact with the conical disks suppresses such vibrations in the arcs.

The influence of the CVT oil on such frictional vibrations has also not been described before, so that up until now those oils have been developed merely for friction that is high and is stable over time, as well as for low wear.

While it is known that with the movable CVT conical disks (movable disks) tilting play between the shaft and the movable disk has an effect on the efficiency, no vibrational bending, tilting, or wobbling motions of the movable disks have been described heretofore.

To solve that problem, it can therefore be necessary to consider more than one of the influenceable parameters, and thus, for example, to combine certain properties of the oil with certain mechanical configurations.

In accordance with the invention the problem is solved by a belt-driven conical-pulley transmission having pairs of conical disks on the input and output sides, each having a fixed disk and a movable disk, which are positioned in each case on shafts on the input side and on the output side, and are connectable by means of a endless torque-transmitting means for transmitting the torque, where at least one of the listed factors is optimized in terms of the acoustics of the transmission:

a viscous or hydraulic medium in the form of oil;

the surface quality of the contact regions between the conical disk and the endless torque-transmitting means;

the geometry of at least one conical disk;

the damping of at least one conical disk; and

the guidance of at least one conical disk.

It can be advantageous to use an oil having a coefficient of friction that is insensitive to the frictional speed. It can also be advantageous to optimize the contact surfaces between the conical disk and the endless torque-transmitting means, for example in regard to their topography.

Furthermore, it can be advantageous to provide at least one conical disk that is optimized for rigidity and/or at least one damped conical disk. It can also prove advantageous to integrate into the transmission at least one conical disk that is radially outwardly guided.

In addition, the present invention relates to a motor vehicle having a transmission in accordance with the invention.

### BRIEF DESCRIPTION OF THE DRAWINGS

The structure, operation, and advantages of the present invention will become further apparent upon consideration of the following description, taken in conjunction with the accompanying drawings in which:

FIG. 1 is a partial view of a belt-driven conical-pulley transmission;

FIG. 2 is an illustration of another embodiment, corresponding essentially to

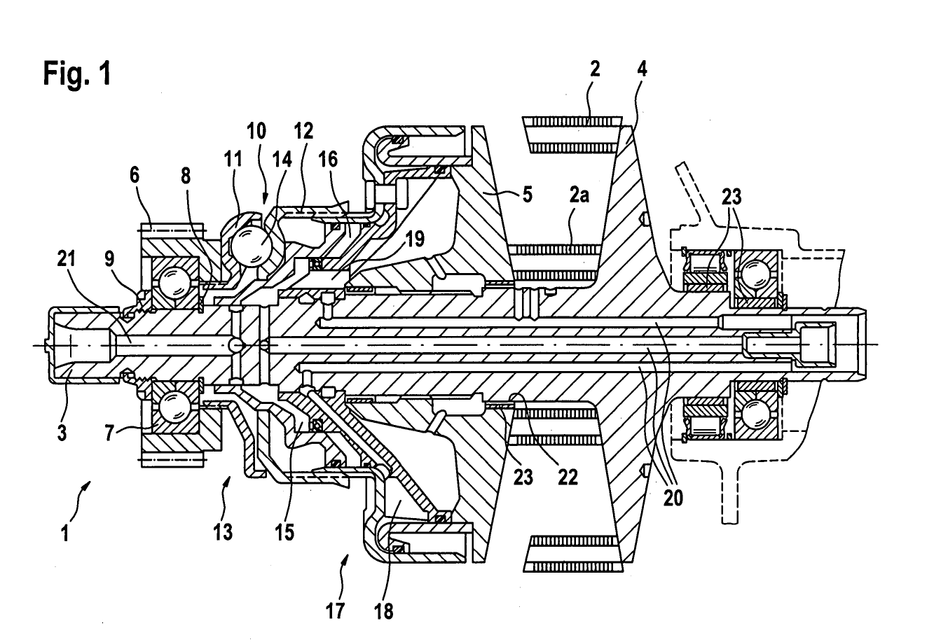

FIG. 1;

FIGS. 3 and 4 are graphs of correlations of coefficients of friction; and

FIGS. 5 and 6 are schematic configuration possibilities for movable disks.

### DESCRIPTION OF THE PREFERRED EMBODIMENTS

FIG. 1 shows only a part of a belt-driven conical-pulley transmission, namely the input side of the belt-driven conical-pulley transmission 1, which is driven by a drive engine, for example an internal combustion engine. In a fully constructed belt-driven conical-pulley transmission, there is associated with the input-side part a complementarily designed output-side part of the continuously variable belt-driven conical-pulley transmission, the two parts being connected by an endless torque-transmitting means in the form of a plate-link chain 2, for example for transferring torque. Belt-driven conical-pulley transmission 1 has a shaft 3 on its input side, which is designed in the illustrated exemplary embodiment in a single piece with a stationary conical disk or fixed disk 4. In the axial longitudinal direction of shaft 3, that axially fixed conical disk 4 is positioned close to and opposite an axially displaceable conical disk or movable disk 5.

In the illustration according to FIG. 1, plate-link chain 2 is shown in a radial outer position on disk pair 4, 5 on the input side, resulting from the fact that the axially displaceable conical disk 5 is shifted toward the right in the drawing, and that shifting movement of axially displaceable conical disk 5 results in a movement of plate-link chain 2 in the radial outward direction, producing a change in the transmission ratio of the transmission toward greater speed.

Axially displaceable conical disk 5 can also be shifted to the left in the plane of the drawing in a known manner, where in that position plate-link chain 2 is in a radially inner position (which is given reference numeral 2a), producing a transmission ratio of belt-driven conical-pulley transmission 1 in the direction of a slower speed.

The torque provided by a drive engine, not shown in detail, is introduced into the input side part of the belt-driven conical-pulley transmission shown in FIG. 1 by way of a gear 6 mounted on shaft 3. Gear 6 is supported on shaft 3 by means of a roller bearing in the form of a ball bearing 7 that absorbs axial and radial forces, and which is set on shaft 3 by means of a washer 8 and a shaft nut 9. Between gear 6 and axially displaceable conical disk 5 is a torque sensor 10, with which a spreader disk configuration 13 having an axially fixed spreader disk 11 and an axially displaceable spreader disk 12 is associated. Located between the two spreader disks 11′ 12 are roller elements, for example in the form of the illustrated balls 14.

A torque introduced through gear 6 results in the formation of an angle of rotation between axially stationary spreader disk 11 and axially displaceable spreader disk 12, which results in an axial displacement of spreader disk 12 because of start-up ramps located on the latter, onto which the balls 14 run up, thus causing an axial offset of the spreader disks with respect to each other.

Torque sensor 10 has two pressure chambers 15, 16, of which first pressure chamber 15 is intended to be charged with a pressure medium as a function of the torque introduced, and second pressure chamber 16 is supplied with pressure medium as a function of the transmission ratio of the transmission.

To produce the clamping force that is applied as a normal force to plate-link chain 2 between axially stationary disk 4 and axially displaceable disk 5, a piston and cylinder unit 17 is provided which has two pressure chambers 18, 19. First pressure chamber 18 changes the pressure on plate-link chain 2 as a function of the transmission ratio, and second pressure chamber 19 serves in combination with torque-dependent pressure chamber 15 of torque sensor 10 to increase or reduce the clamping force that is applied to plate-link chain 2 between conical disks 4, 5.

To supply pressure medium, shaft 3 has three conduits 20, through which pressure medium is fed into the pressure chambers from a pump, which is not shown. The pressure medium is able to drain from shaft 3 through a drain conduit 21 on the outlet side, and can be conducted back to the circuit.

Applying pressure to pressure chambers 15, 16, 18, 19 results in a torque-dependent and ratio-dependent shifting of axially displaceable conical disk 5 on shaft 3. To seat shiftable conical disk 5, shaft 3 has centering surfaces 22, which serve as a sliding fit for displaceable conical disk 5.

As can be readily seen from FIG. 1, in the bearing regions of conical disk 5 on shaft 3, belt-driven conical-pulley transmission 1 has a respective sound damping device 23. For that purpose the sound damping device can have a ring body and a damping insert, or it can consist only of a damping insert.

The reference numerals used in FIG. 1 also refer to the essentially comparable features of the other figures. Thus the figures are to be regarded as a unit in that respect. For the sake of clarity, only the reference numerals that go beyond those in FIG. 1 are used in the other figures.

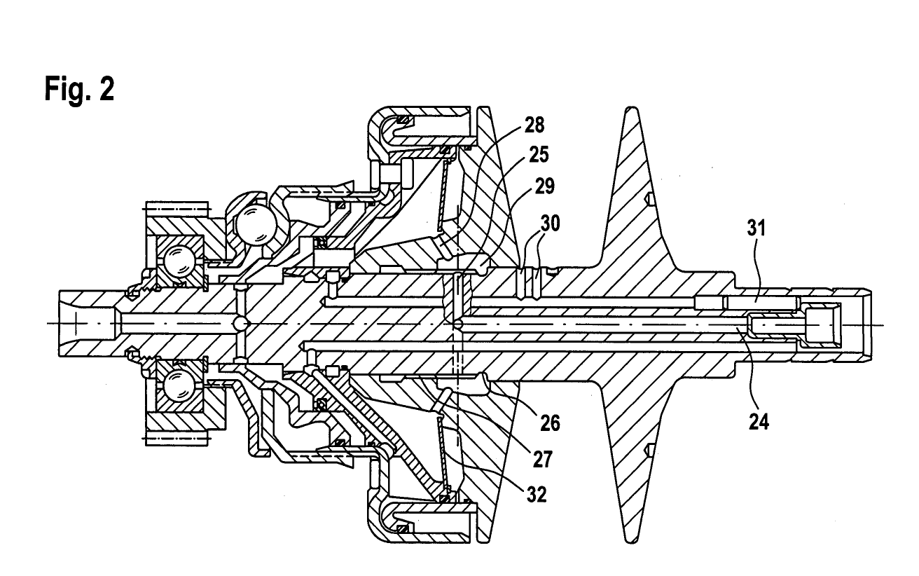

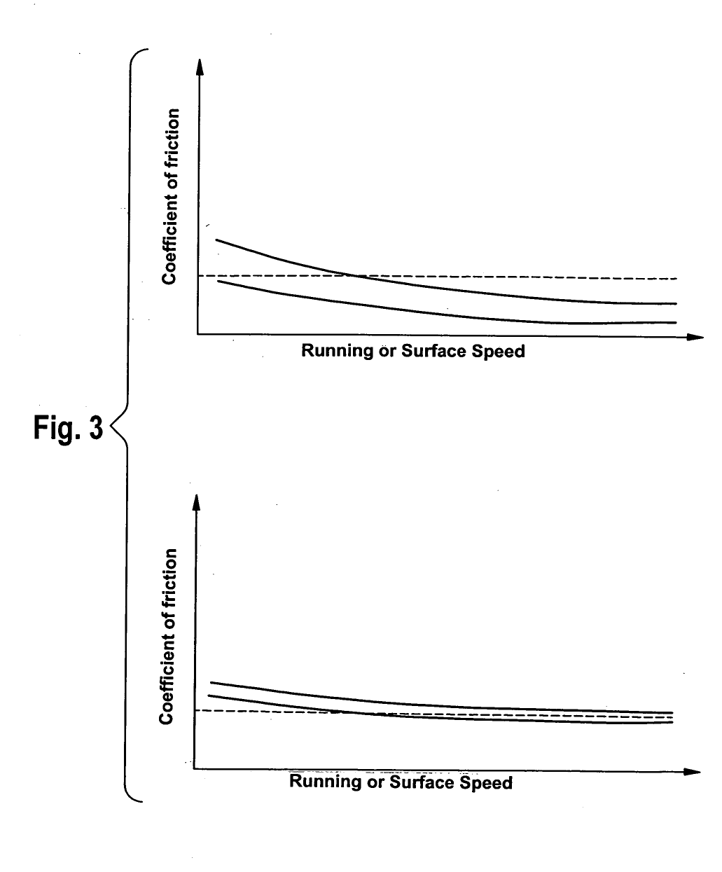

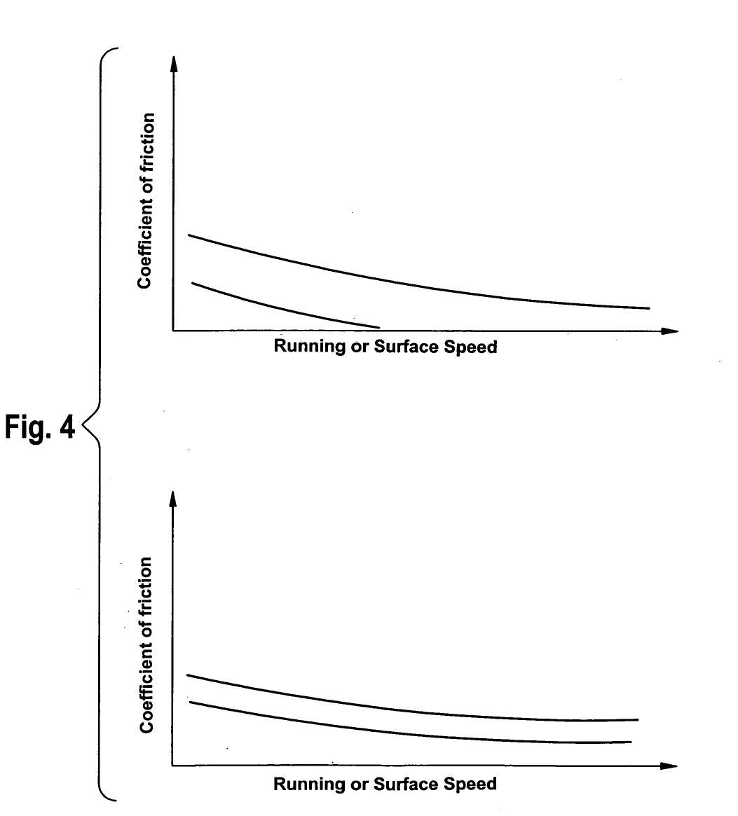

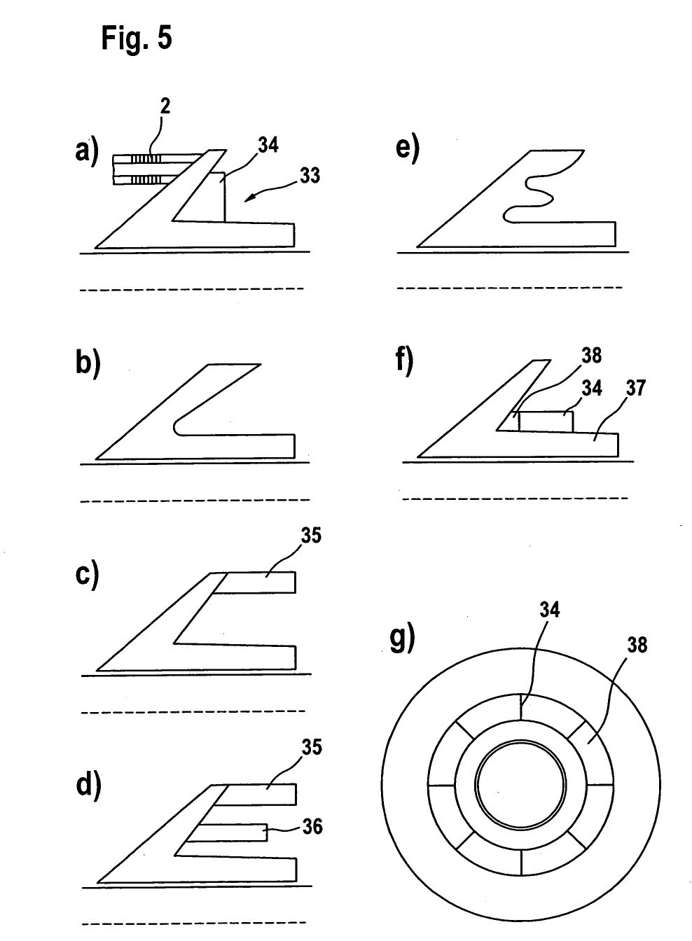

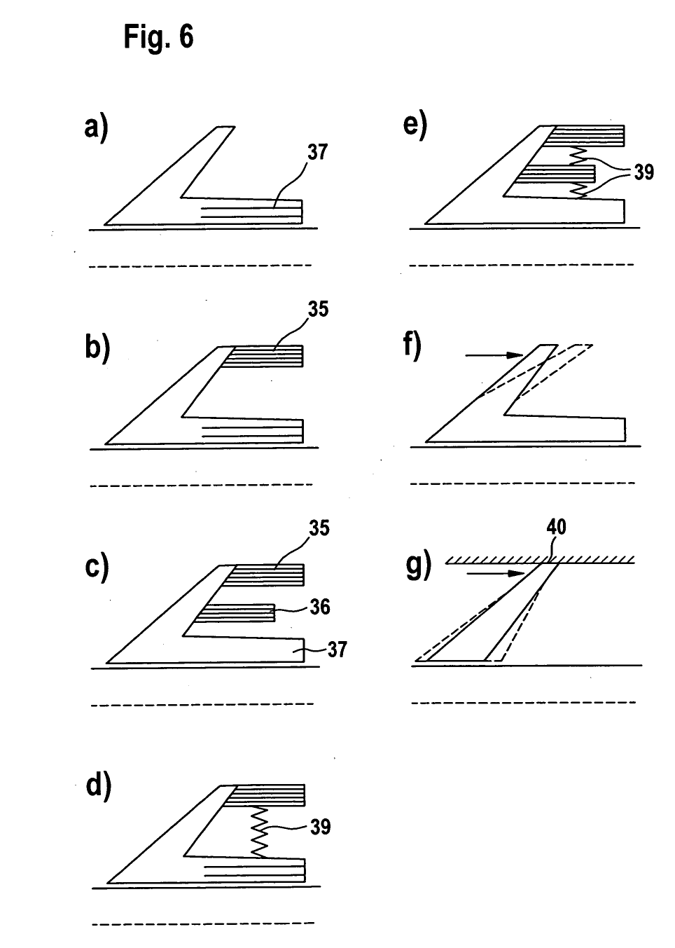

In FIG. 2, only the middle one of the three conduits 20 is configured in a form that is modified from FIG. 1. It is evident that bore 24, which forms the central conduit 20, and which is produced as a blind bore from the side shown on the right in FIGS. 1 and 2, is significantly shorter than in FIG. 1. Such blind bores are complex and expensive to produce and require a very high degree of precision in manufacturing. The expense of production and the requirements in terms of process reliability increase disproportionately with the length. Thus shortening a bore of that sort has a favorable effect on, for example, the production costs.

In the area of the floor of that bore 24 the lateral bore 25 branches off; there can be a plurality of those arranged around the circumference. In the case shown, that lateral bore 25 is shown as a radial bore; however, it can also be produced at a different angle as an inclined bore. Bore 25 penetrates the outer surface of shaft 3 at a place which is independent of the operating state, i.e., for example independent of the transmission ratio setting, in an area which is always covered by movable disk 5.

By shifting lateral bore 25 to the zone covered by movable disk 5, shaft 3 can be made axially shorter, enabling construction space to be saved. In addition, shortening shaft 3 can also result in reduced strain.

The mouth of the conduit or lateral bore 25 can be located for example in the area of the groove 26, which is adjacent to the centering surface 22 of the shaft. That can be particularly advantageous if the tooth system 27, which connects movable disk 5 to shaft 3 so that it can be shifted axially but is rotationally fixed, is subjected to heavy loads, for example by the transmission of torque.

But in many cases the load on the tooth system 27 will not be the most critical design criterion, so that the mouth of bore 25 can be placed in the area of that tooth system, as shown in FIG. 2. Placing lateral bore 25 within the toothed area 27 instead of in the groove 26 produces an advantage through the fact that a greater section modulus is present, which reduces the bending stress in the surface layer region. In addition, the polar moment of inertia is greater at that location, while the critical fiber, which is disturbed by lateral bore 25, remains at an approximately constant radius. That results in a significant reduction of the tensions in the critical area around the mouth of lateral bore 25 between the teeth of tooth system 27. The system of supplying with hydraulic fluid is identical in FIGS. 1 and 2, since pressure chambers 15 and 19 are connected to each other and movable disk 5 has connecting bores 28 which connect the area of the tooth system 27 with pressure chamber 19. In the figures, movable disk 5 is in its most extreme left position, which corresponds to the start-up transmission ratio or underdrive. If movable disk 5 is now shifted to the right in the direction of fixed disk 4, there is always part of the hollow space or of chamber 29 over the mouth of the lateral bore or of conduit 25, so that the necessary fluid supply is always ensured, just as in FIG. 1. Also as in FIG. 1, there are two shift states for pressure chamber 16, which depend on the axial position of movable disk 5. In the illustrated position the control bores 30 are free, so that the conduit 20 which is connected to them and is closed axially with a stopper 31, and the pressure chamber 16, which is connected to the latter through a conduit (not shown), are not pressurized or have only ambient pressure. If movable disk 5 is now moved toward fixed disk 4, it passes over control bores 30, so that starting at a certain distance chamber 29 comes to rest over the mouths of control bores 30. In chamber 29, however, a high pressure dependent on the torque prevails, which is then also conveyed through control bores 30 and conduit 20 into pressure chamber 16, so that high pressure is also present there. In that way two shift states are realized, which control the clamping force as a function of the transmission ratio.

In addition, in the FIG. 2 embodiment there is provided a disk spring that moves movable disk 5 to a predetermined axial position when transmission 1 is not under pressure, enabling a transmission ratio of transmission 1 to be set which prevents excessive loads, for example when the motor vehicle is towed.

FIG. 3 includes two graphs that show the gradient of the coefficient of friction over a range of running or surface speed and as a function of the contact pressure. The running or surface speed is shown on the abscissa and the coefficient of friction on the ordinate. The dashed line is to be seen as a reference value, and represents a coefficient of friction, which can be, for example, μ=0.12. As can be seen from both figures, the coefficient of friction is a function of the running or surface speed, tending to decrease as the running or surface speed increases.

As explained earlier, with clutches, for example, a coefficient of friction that drops as the running or surface speed increases leads to grabbing, and hence to a decline in comfort. An effort should therefore be made to keep that decline in the coefficient of friction over the change of running or surface speed as small as possible.

The coefficient of friction gradient shown in FIG. 3 occurs at the place of contact between the rocker members of the chain and the contact surfaces of the disks that operate together with them. The chain, or endless torque-transmitting means, is under load both in the running direction, from the torque that is being transmitted, and also transversely to the running direction, primarily from the clamping force. That clamping force must be chosen so that the torque to be transmitted can be conveyed to the other set of disks with adequate reliability against slippage.

The spacing of the curves in the direction of the ordinate represents the scatter range of the coefficient of friction as a function of the clamping force or contact pressure. The bottom line represents a low contact pressure and the upper one in each case represents a higher contact pressure.

When comparing the former construction according to the upper graph and the embodiment according to the invention as shown in the lower graph, it is noticeable that at first the scatter range that is bounded by the two curves is smaller, resulting in a lesser dependence of the coefficient of friction on the contact pressure or clamping pressure existing at the time. Expressed in different terms, the embodiment according to the present invention (the lower graph) is less sensitive to changes in contact pressure.

It can also be seen from FIG. 3 that the curves in the lower graph are flatter, which means that the coefficient of friction is less dependent on the running or surface speed. Through that flatter, negative gradient of the coefficient of friction over the range of running or surface speed, a more stable behavior of the coefficient of friction is achieved. At the same time, it is less problematic if the curves are shifted quasi parallel from top to bottom or vice versa, than if their slope were to change, since any change in slope represents a greater dependency of the coefficient of friction on the running or surface speed.

Such a clearly defined pattern of the coefficient of friction over the range of running or surface speed and over the range of contact pressure, as shown in the lower graph of FIG. 3, results in a suppression of the vibration that is caused by the variation of the coefficient of friction of the steel-to-steel contact between the belt or chain and the conical disks. The vibration can be offset at the place where it develops, through the use of an appropriate oil with such a coefficient of friction variation.

The graphs in FIG. 4 are organized essentially like those in FIG. 3. They do not show the dependency on the oil used, but on the surface characteristics. What is shown in FIG. 3 with regard to interpretation and improvement also applies to FIG. 4; that is, the lower graph shows a significant improvement in the conditions.

The upper graph in FIG. 4 shows the conditions at a polished surface, while the lower graph in the figure shows the coefficient of friction as a function of the running or surface speed and the contact pressure with surface characteristic values according to the present invention. Those surface characteristic values are producible by a finishing process, for example, where the friction parameters have the correct variation and also retain it over a relatively long running time. For example, noise phenomena occur immediately with smoother surfaces, while with rougher surfaces they occur later, or in the most favorable case not at all. An improvement of that sort in regard to the noise behavior is also achievable by reducing the clamping force or contact pressure.

Investigations with simulations and measurements have shown that the vibration behavior, and hence the noise behavior, are influenced positively by an increased tilting stiffness of the axially movable disks, with that applying in particular, but not exclusively, in regard to the movable disk on the output side. In general it has turned out that an increased bending stiffness, whereby the opening of the conical disks when under load is reduced, especially of the set of conical disks on the output side, the vibration amplitude, which is significant in regard to the noise, is lessened. A comparable effect can be achieved through increased damping at that location.

FIGS. 5 and 6 each show a schematic profile of a movable disk, with only the upper half of the rotationally symmetrical profile being shown in each case.

FIG. 5 shows in each of the schematic exemplary embodiments a) through e) a stiffening of the disk itself. At the same time, FIGS. 5 and 6 each show schematically a part of the axially moving disk or movable disk 33 on the output side; comparable designs can also be carried over to the movable disk 5 on the input side.

The movable disk 33 shown in FIG. 5a has, in its area facing away from the endless torque-transmitting means 2, a plurality of radially-extending stiffening ribs 34 distributed circumferentially, which reduces displacement of the radially-outwardly-extending part of disk 33 when under an axial force, or in the most favorable case prevents it; thus it counteracts an enlargement of the axial spacing of the pair of disks.

Movable disk 33 according to FIG. 5b has a design in which the radially outwardly extending part of movable disk 33 is reinforced by having its wall thickness increase in the radially outward direction. That is achieved by an appropriate design of the contour of the disk facing away from endless torque-transmitting means 2. The course of that contour, which is shown in the drawing as even, or a wall of constant thickness, can also be modified so that the wall thickness increases in several steps.

To stiffen movable disk 33 in the axial direction, a stiffening collar can also be applied radially at the outside, as shown in FIG. 5c. FIG. 5d shows, in addition to stiffening collar 35 located radially at the outside, an additional stiffening collar 36 that is located further radially inward and thus can in that case also serve as a partition between two pressure chambers.

In FIGS. 5c and 5d, stiffening collars 35 and 36 are shown as separate parts or circular rings, which have to be connected to movable disk 33. FIG. 5e shows a possibility for constructing stiffening collar 35 and/or stiffening collar 36 in a single piece with movable disk 33, with the possibility of giving consideration to a production-friendly design in a beneficial way.

FIGS. 5f and 5g show a stiffening of the connection of the disk to the shaft. Here, first of all, hub 37 of movable disk 33 is connected to the radially outwardly extending part of movable disk 33 by means of a stiffening ring 38, so that a deformation of that area is at least reduced. Furthermore, there are again radial stiffening ribs 34, which are connected on one side to stiffening ring 38 and on the other side to hub 37 of movable disk 33.

FIGS. 6a through 6e show the principles of damping possibilities for the axially moving disk or movable disk 33 on the output side, which are also applicable, however, to the axially moving disk or movable disk 5 on the input side.

FIG. 6a shows first of all a subdivision of hub 37 into individual lamellae. That bundle of lamellae is pressed together by the clamping pressure that is applied through the hydraulic medium and thus produces a damping effect.

In FIG. 6b, in addition, stiffening collar 35 is constructed as a bundle of lamellae, which is again pressed together by the clamping pressure. According to FIG. 6c, stiffening collar 36, which is located radially further inwardly, can also be constructed as a bundle of lamellae; that stiffening collar 36 can again be utilized as a partition between different pressure chambers. Alternatively, in an embodiment in accordance with FIG. 6c the hub 37 can also be subdivided into individual lamellae.

FIGS. 6d and 6e both show springs 39, which increase the friction between the individual cylinders of lamellae through additional radial clamping pressure, which simultaneously increases the damping effect. It would also be possible in FIG. 6e to construct hub 37 as a bundle of lamellae.

FIGS. 6f and 6g show a different approach to a solution, which involves changing the direction of tilt of the movable disk. With the usual guidance of the movable disk by its radial inner region or by its hub 37, the radial outer region of that movable disk shows the greatest deflection in the direction of tilting. To counter that, it is possible in principle to guide the movable disk at the outside, so that its radially outer regions lie against the outer guide 40 and hence cannot deflect there. Tilting would then occur at the radially inner region of movable disk 33, against which countermeasures could again be taken as described above. In that case, care must be taken, however, to avoid jamming or clamping of movable disk 33 between the guides.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A belt-driven conical-pulley transmission comprising:
a pair of conical disks on a power input side and carried on an input shaft, and a pair of conical disks on an output side of the transmission and carried on an output shaft, each pair of conical disks including an axially fixed disk and an axially movable disk;
an endless torque-transmitting means extending around and in contact with the input side disks and the output side disks for transmitting torque between the pairs of disks;
wherein the transmission is optimized to minimize noise emitted by the transmission when it is in operation, the optimization selected from the group consisting of:
a viscous medium in the form of oil,
a surface quality of the contact zones between the disk pairs and the endless torque-transmitting means,
a geometry of at least one conical disk,
a damping of at least one conical disk, and
guidance of at least one conical disk.

2. A belt-driven conical-pulley transmission in accordance with claim 1, including an oil applied between the conical disks and the endless torque-transmitting means and providing a coefficient of friction that is insensitive to frictional speed.

3. A belt-driven conical-pulley transmission in accordance with claim 1, including optimized contact surfaces between the conical disks and the endless torque-transmitting means.

4. A belt-driven conical-pulley transmission in accordance with claim 1, including at least one conical disk optimized for stiffness.

5. A belt-driven conical-pulley transmission in accordance with claim 1, including at least one damped conical disk.

6. A belt-driven conical-pulley transmission in accordance with claim 1, including at least one conical disk that is outwardly radially guided.

7. A motor vehicle comprising: a drive train with a transmission having a pair of conical disks on a power input side and carried on an input shaft, and a pair of conical disks on an output side of the transmission and carried on an output shaft, each pair of conical disks including an axially fixed disk and an axially movable disk;
an endless torque-transmitting means extending around and in contact with the input side disks and the output side disks for transmitting torque between the pairs of disks;
wherein the transmission is optimized to minimize noise emitted by the transmission when it is in operation, the optimization selected from the group consisting of:
a viscous medium in the form of oil,
a surface quality of the contact zones between the disk pairs and the endless torque-transmitting means,
a geometry of at least one conical disk,
a damping of at least one conical disk, and
guidance of at least one conical disk.
